(19) United States
(12) Patent Application Publication
(10) Pub. No.: US 2020/0122188 A1
(43) Pub. Date: Apr. 23, 2020

(54) HANDHELD CANNABIS PRESS AND DISPENSER

(71) Applicant: David M. Tumey, Coral Springs, FL (US)

(72) Inventor: David M. Tumey, Coral Springs, FL (US)

(73) Assignee: Bluegrass Farmacurticals, LLC, Belton, KY (US)

(21) Appl. No.: 16/597,875

(22) Filed: Oct. 10, 2019

Related U.S. Application Data
(60) Provisional application No. 62/747,200, filed on Oct. 18, 2018.

(51) Int. Cl. B05C 17/005; A24B 15/24

(52) U.S. Cl. CPC B05C 17/00526; A24B 15/24; B05C 17/00576; B05C 17/00503; B05C 17/00546

(57) ABSTRACT

A handheld gun-type cannabis rosin oil press and dispenser is described and claimed having a piston feeding mechanism comprising a trigger arranged to drive clamping means to grasp a piston and move the piston towards a melt chamber of the gun to feed the piston face against the cannabis floral material in the melt chamber. The force of the piston combined with the precisely controlled heat of the chamber causes the extraction of rosin oil from the cannabis material and subsequent dispensing from the outlet orifice of the gun.

### FIELD OF THE INVENTION

The present general inventive concept relates to handheld piston operated hot melt dispensers, and in particular a handheld cannabis heated press and dispenser for dispensing rosin oil.

### BACKGROUND OF THE INVENTION

Myriad propositions have been made to provide apparatus for heating, melting and dispensing material supplied in the form of a cylindrical rod or slug with or without the use of a piston. Such apparatus usually comprises a melt body having a liquefier chamber in which material is melted, an inlet for the rod or slug and an outlet comprising an orifice or extrusion array element for dispensing melted material, and means for heating the melt body so that composition fed into the melt chamber under force may be dispensed in molten condition from the orifice or extrusion array element. Such apparatus finds use in various fields of application, and is of particular interest in the field of applicators for hot melt adhesives and sealants and especially in hot-melt glue guns having provision for feeding a rod of adhesive to the melt body, for example by a trigger operated means.

The present general inventive concept is concerned with a heated press for melting and dispensing cannabis rosin oil and is more particularly concerned with a hand held gun-type device comprising improved feeding means adapted to feed a piston to apply pressure to cannabis floral material within the melt body.

Rod feeding means employed in hand held hot-melt gun apparatus generally includes a trigger and associated mechanism arranged to grasp a rod of composition to be fed, and to advance it towards the melt chamber. It is a general practice to provide an inlet sheath of durable material at the entrance to the melt chamber which is intended to assist in guiding the composition into the melt chamber and also to grasp the surface of the composition as it is fed into the melt chamber and to minimize the flow of melted material from the melt chamber inlet. For example, there is described in GB Patent Specification No. 1402648 a hand held hot-melt glue gun having feeding means for feeding a cylindrical rod of hot melt material in solid form through an inlet sheath into a melt body, under the control of an operator, in which the feeding means comprises a carriage mounted in such a way to permit movement towards and away from the melt body, a clamping element pivotally mounted on the carriage and a trigger connected to the clamp element by connecting means and arranged to be actuated by the operator to pivot the clamp element into engagement with the cylindrical rod of hot-melt supported by the carriage to grasp the rod and, on added pressure on the trigger by the operator, to controllably feed the rod into the melt chamber. The clamping means comprises a blade element by which the rod is engaged in the operation of the feeding means to feed the rod into the melt chamber.

The feeding means described in GB No. 1402648 is effective to feed cylindrical rod adhesive through the inlet sheath and into the melt chamber. However when excessive pressure is exerted on the trigger, the blade element may tend to indent or otherwise deform the rod. Deformation of the rod in many cases is not generally deleterious to effective operation of melt guns, however, this deformation could be detrimental to a piston, for example, causing excessive wear or even failure. The problem of outflow of melted material from the inlet of a melt chamber has been recognized previously and various means have been proposed to ameliorate the problem. One proposed solution involves use of an inlet sheath of durable material having internal lip means which are expanded by passage of the rod so as to grasp the outer surfaces of the rod. However, severe deformation of the rod surfaces renders it impossible to rely upon the inlet sheath to provide a sufficient seal on remaining rod entering the melt chamber to exclude the possibility of melted material being forced between the inlet sheath and the rod.

Another known disadvantage associated with currently available hand operated hot-melt guns, with or without a piston, has been that a comparatively large application force is required to maintain the grasping of the rod or piston whilst the carriage and clamp are moved forwards toward the melt chamber. Not only may this accentuate the disadvantage of deforming the rod or piston but also may give rise to control challenges and operator fatigue.

Among the several objects of the present general inventive concept are to provide an improved piston grasping and feeding means.

### SUMMARY OF THE INVENTION

The invention provides in one of its aspects a hand held gun-type cannabis rosin oil press comprising a melt body having a melt chamber and feeding means for feeding a piston against cannabis floral material in solid form, the feeding means comprising clamping means comprising a carriage mounted for sliding movement towards and away from the melt body and having a shaped portion shaped to accept a piston to be fed to the melt body, a clamp element pivotally mounted on the carriage and having a clamping arm portion disposed along the direction in which the carriage is arranged to move and a crank arm portion having an operating portion arranged to co-operate with pressure means of pivotally mounted connecting means in response to operation of a trigger of the gun whereby upon operation of the trigger the clamp element may be caused to pivot into engagement with a piston in the carriage to grasp the piston against said shaped portion and on continued operation of the trigger the clamp element may be caused to move with the carriage to feed the piston towards the melt chamber applying force on the cannabis material, the operating portion of the crank arm having a convex surface and being so disposed that an acute angle between a plane which includes a line of contact between the convex surface and the pressure means and a plane which includes the direction in which the carriage is arranged to move is increased as the clamp element is pivoted to grasp the piston whereby to increase a component of force applied in the direction in which the carriage is arranged to move.

The invention provides in another of its aspects a handheld gun-type cannabis rosin oil press comprising a melt body having a melt chamber and feeding means for feeding a piston against cannabis floral material in solid form, the feeding means comprising clamping means comprising a carriage mounted for sliding movement towards and away from the melt body and having a shaped portion shaped to accept a piston to be fed to the melt body, a clamp element pivotally mounted on the carriage and having a clamping arm portion disposed along the direction in which the carriage is arranged to move and a crank arm portion having an operating portion arranged to cooperate with pressure means of pivotally mounted connecting means in response to operation of a trigger of the gun whereby upon operation of the trigger the clamp element may be caused to pivot into engagement with a piston in the carriage to grasp the piston against said shaped portion and on continued operation of the trigger the clamp element may be caused to move with the carriage to feed the piston towards the melt chamber applying force on the cannabis material, the operating portion of the crank arm having a convex surface and being so disposed that prior to operation of the trigger means the line of contact between the convex portion and the pressure means lies to the rear (in the direction in which the carriage is arranged to move) of a plane P including the axis of rotation of the clamp element on the carriage and which is normal to the direction in which the carriage is arranged to move and that after the piston has been grasped the line of contact between the convex portion and the pressure means lies before said plane in the direction in which the carriage is arranged to move.

The invention provides in another of its aspects a handheld gun-type cannabis rosin oil press comprising a melt body having a melt chamber and feeding means for feeding a piston into the melt body against cannabis floral material in solid form, under the control of an operator into the melt chamber, the feeding means comprising clamping means comprising a carriage mounted for sliding movement towards and away from the melt body and having a shaped portion shaped to accept a piston to be fed to the melt body, a clamp element pivotally mounted on the carriage and a trigger connected with the clamp element by connecting means and arranged to be operated by the operator to pivot the clamp element into engagement with a piston in the carriage to grasp the piston against said shaped portion and, on continued pressure on the trigger by the operator, to move the clamp element towards the melt chamber thus to feed the piston into the melt chamber applying force on the cannabis material, the clamp element comprising a clamping arm portion in the form of a rack providing several blade portions arranged transversely of the direction in which the carriage is arranged to move.

A preferred embodiment of a handheld gun-type cannabis rosin oil press according to the present general inventive concept is hereinafter described by way of example to illustrate the present general inventive concept. This illustrative gun comprises a melt body having a melt chamber and feeding means according to the present general inventive concept for feeding a piston into the melt body against cannabis floral material in solid form. The feeding means includes clamping means comprising a carriage mounted for sliding movement towards and away from the melt body and having a shaped portion shaped as a curved portion to accept a piston to be fed to the melt body, and a clamp element pivotally mounted on the carriage and having a clamping arm portion disposed along the direction in which the carriage is arranged to move. The clamping arm portion is in the form of a curved element having a piston engaging surface. The piston engaging surface of the illustrative gun has several blade portions arranged transversely of the direction in which the carriage is arranged to move. The blade portions are arranged so that two or more thereof may engage the piston to grasp it against the shaped portion. The clamp element also comprises a crank arm portion having an operating portion in the form of a cam lobe arranged to cooperate with a cam surface of a lever which provides pressure means of pivotally mounted connecting means in response to operation of a trigger of the gun. Upon operation of the trigger the clamp element is caused to pivot into engagement with a piston in the carriage to grasp the piston against said shaped portion and on continued operation of the trigger the clamp element is caused to move with the carriage to feed the piston towards the melt chamber applying pressure to the cannabis material. The cam lobe of the crank arm has a convex surface so disposed that an acute angle between a plane which includes a line of contact between the convex surface and the cam surface and a plane which includes the direction in which the carriage is arranged to move is increased as the clamp element is pivoted to grasp the piston. The cam lobe is also so disposed that prior to operation of the trigger means the line of contact between the convex surface and the cam surface lies to the rear (in the direction in which the carriage is arranged to move) of a plane including the axis of rotation of the clamp element on the carriage and which is normal to the direction in which the carriage is arranged to move and that after the piston has been grasped the line of contact between the convex portion and the pressure means lies before said plane in the direction in which the carriage is arranged to move.

In the illustrative gun, the clamp element comprises stabilizing pins located to cooperate with recesses in portions of the carriage located in front of the pivotal mounting of the clamp element (in the direction in which the carriage is arranged to move) as the carriage is moved towards the melt chamber, and to limit the extent of pivotal movement of the clamp element.

In the illustrative gun the trigger is slidably mounted in body portions of the gun and arranged to operate the connecting lever to move the clamp element to grasp and feed a piston against the recoil action of a spring. The connecting lever carries a roll 206 trapped in a curved slot, so that the pressure exerted to rotate the connecting lever is varied with increased feeding movement of the trigger.

In the illustrative gun a resilient sheath is mounted at the entrance to the melt chamber which is arranged to be expanded by a piston as it is fed into the melt chamber.

In the illustrative gun, a resilient mouthpiece is mounted on body portions of the gun through which a piston may be supplied to the feeding means.

The body of the illustrative gun comprises two parts of robust polymer material secured together with screws or the like to provide a gun assembly for use in the hand of an operator.

By imparting curvature to the piston engaging surface of the clamping arm portion of the gun according to the present general inventive concept it is possible to grasp satisfactorily pistons of various dimensions, e.g., lengths, and by arranging that two or more blade portions on the piston engaging surface of the clamping arm portion may engage the piston during grasping, substantial deformation of the piston may be minimized. Thus the risk that the seal between the flexible inlet sheath to the melt chamber and the piston may be rendered ineffective to prevent blowback of melted cannabis material from the melt chamber under pressure of the advancing piston is virtually eliminated. Also, due to the shape of a cam surface of the crank arm portion, and its disposition with respect to the direction in which the carriage is arranged to move and with respect to the axis about which the clamp element is arranged to pivot, the effort applied to the trigger during a feeding stroke of the carriage is applied (after initial grasping has been accomplished) primarily in the direction in which the carriage is arranged to move. Preferably the axis about which the clamp element is arranged to pivot is also positioned sufficiently close to the surface of a piston to be fed that the force transfer occurs in such a way that the clamping force for the piston is not directly affected by pressure on the trigger but rather by self clamping i.e. increasing self-clamping with increasing trigger force. In this way, excessive deformation of the piston is avoided, and the effort required to effect feeding of the piston is applied principally to movement of the carriage thus providing for convenient operation and improved trigger control.

Thus, a gun-type cannabis rosin oil press having feeding means according to the present generally inventive concept can be used with advantage to feed a piston into a melting chamber of high capacity containing cannabis floral material in solid form in a rapid and reliable manner without severely deforming the surface of the piston. This is of considerable importance in relation to handheld melt guns where the strength of applied trigger force varies from operator to operator and may be large in relation to melt guns which are designed to accept floral material with considerable size tolerances.

There now follows a description to be read with the accompanying drawings of the illustrative gun-type cannabis rosin oil press. It is to be clearly understood that this embodiment has been selected for description by way of example to illustrate the present general inventive concept and is not by way of limitation thereof.

### BRIEF DESCRIPTION OF THE DRAWINGS

FIG. 1 is a side view of the illustrative apparatus with some parts broken away and others in section showing a piston about to be fed to a melt body of the apparatus;

FIG. 2 is an end view of the melt body shown in FIG. 1 viewed from an outlet end of the melt body;

FIG. 3 is a view in section of the melt body indicated in FIG. 1, taken on the line III-III of FIG. 2 and viewed in the direction of the arrows;

FIG. 4 is a view in section of the melt body, taken on the line IV-IV of FIG. 3 and viewed in the direction of the arrows;

FIG. 5 is a view of a carriage of clamping means of the illustrative gun showing a clamp element in chain dotted lines in position prior to a feed stroke of the clamping means;

FIG. 6 is a view of the carriage and clamp element of the illustrative gun taken in the direction of the arrow VI on FIG. 5;

FIG. 7 is a view of feeding means of the illustrative gun with some parts broken away showing parts in positions occupied prior to a feeding stroke to feed a piston to a melt chamber of the gun; and

FIGS. 8 and 9 are views of the feeding means similar to FIG. 7 but showing parts in positions occupied partway through a feeding stroke and at the end of a feeding stroke respectively.

### DETAILED DESCRIPTION OF THE PREFERRED EMBODIMENT

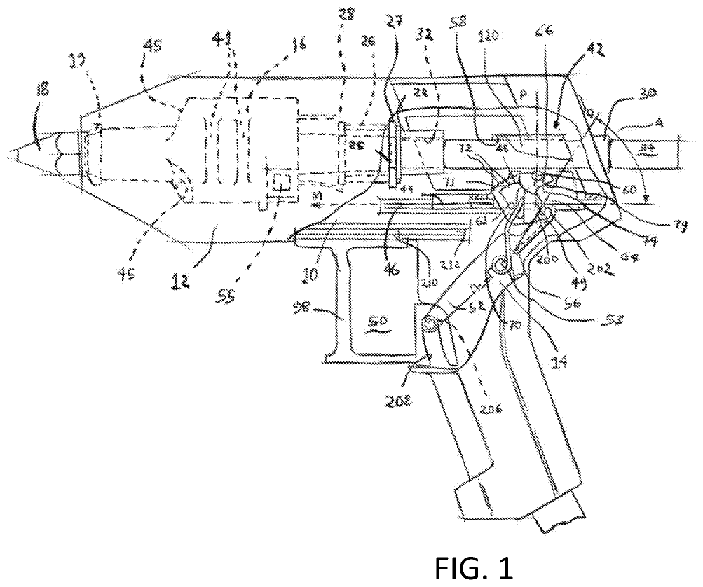

The illustrative gun-type cannabis rosin oil press is intended for use with pistons of circular cross-section and comprises a gun body having two parts 10, 12; the part 12 of the body is broken away in FIG. 1 to show feeding means 14, and other parts of the illustrative apparatus. In addition to the feeding means the gun-type rosin oil press has a melt body 16 containing a melt chamber 17, electrically operated heating means for heating the melt body, and an extrusion element 18 through which extracted cannabis rosin oil is expelled from the melt chamber 17.

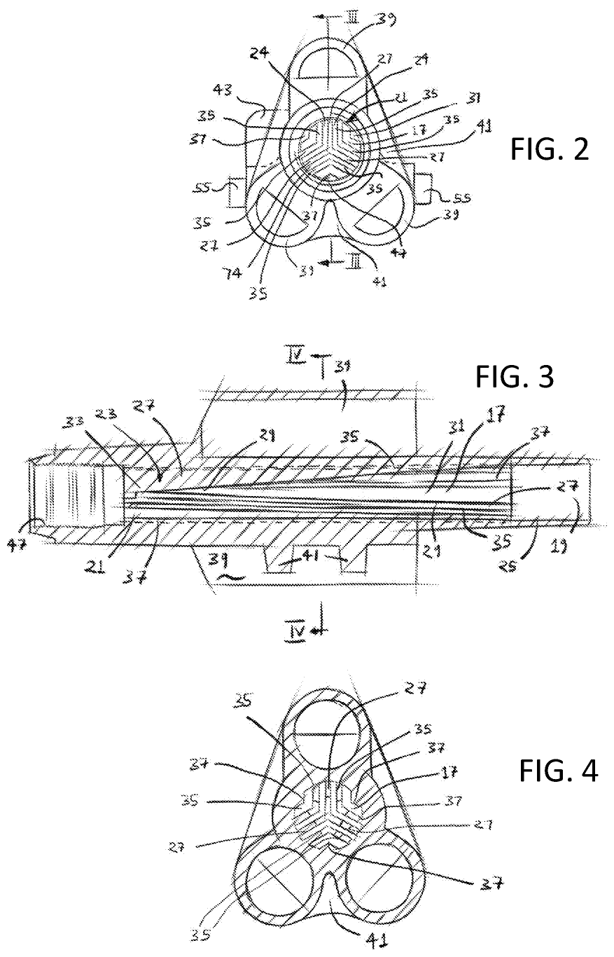

The melt body 16 is constructed of a heat conductive alloy and is formed with a generally cylindrical melt chamber 17 (FIGS. 2, 3 and 4) in which solid cannabis floral material fed to the chamber 17 under force of a piston 54 may be heated. The chamber 17 has a circular inlet 19 through which the piston 54 enters the chamber 17, and an outlet 21 from which melted cannabis rosin oil may be dispensed. Fin elements 23 are disposed lengthwise within the chamber 17 and extend from a location adjacent the inlet to the outlet. The fin elements 23 protrude from a wall surface of the chamber 17 into a cavity of the melt chamber 17 and extend in directions parallel to the axis of the melt chamber 17 and increase in size towards the outlet. The fin elements comprise major fin elements 27 and sub elements 35 each of which fin elements has a plate-like structure having a substantially triangular configuration (see FIGS. 3 and 4). The fin elements comprise three major elements 27 of similar shape and size spatially disposed with angles of at least substantially 120° between adjacent major elements and which have portions of their larger ends joined together at the outlet 21. The major elements 27 are arranged generally as a tripod within the melt chamber 17 which is effective at least towards the outlet 21 of the melt chamber 17 to separate the melt chamber 17 into three sub-chambers and so that inner edge surfaces 29 of the major elements provide surface portions of a substantially pyramidal shaped opening 31 centrally disposed in the chamber 17 and which narrows to a peak 33 located adjacent the outlet 21. The fin elements also comprise six sub elements 35 disposed in pairs at 120° to each other between adjacent major elements, which also have their larger ends joined together at the outlet 21. Each sub element 35 is disposed parallel to the adjacent major element 27. Inner edge surfaces of the sub elements 35 also provide surface portions of the substantially pyramidal shaped opening 31. The fin elements also comprise singular elements 37 disposed on the wall surface of the melt chamber 17 equidistant from adjacent major elements 35, 27. The singular elements 37 are substantially triangular in both the widthwise and lengthwise direction and increase in size progressively towards the outlet 21. The joints between the major elements 27 and between the sub elements 35 extend over a comparatively short length of the melt chamber, thus to provide a short outlet 21 having a series of slotted fenestrations 24 (see FIG. 2) bounded by the fin elements and disposed about the axis of the melt chamber 17. As can be seen from the drawings, the slotted fenestrations are arranged about the axis of the melt chamber and about the axis of the pyramidal opening, and there are no slotted fenestrations located on the axis of the melt chamber 17.

The melt body comprises three housings 39 each having a tunnel bore having an axis parallel to the axis of the melt chamber 17 for receiving electrically operated resistive heating means in the form of cylindrical self-regulating heaters 45 (FIG. 1) comprising PTC resistors distributed about the chamber 17. The heaters 45 are constructed and arranged so that the melt body may be heated to a maximum temperature of about 200° C. Suitable uniform distribution of the heaters is achieved in the melt body shown together with desirable slim characteristics of the melt body. Webbing 41 and 43 formed between pairs of the housings serve to strengthen the melt body. Locating bosses 55 (FIG. 2) formed on the melt body co-operate with sockets formed in the body parts 10 and 12.

The melt body has a threaded bore 47 coaxial with the melt chamber into which the extrusion element 18 is threaded. The extrusion element 18 contains a spring loaded ball valve (not shown) which is arranged to be opened by pressure of extracted material when the piston 54 is fed into the melt chamber.

An outer surface of the melt body at the inlet is formed to provide a tube 25 onto which a flexible inlet sheath 22 is secured (FIG. 1). The inlet sheath 22 is formed from resilient heat resistant material and has a flange 28 at its forward end and is maintained in place on the tube by a bell shaped sleeve 26. The inlet sheath 22 has an inlet passage coaxial with the melt chamber 17 in the melt body through which a piston 54 may be introduced into the inlet end of the melt chamber 17. The inlet sheath 22 is of circular cross section and is formed with an inner lip portion 32, so that as well as guiding the piston 54 into the melt chamber 17, the tube forms a seal with the surface of the piston 54, militating against escape of extracted rosin oil material from the inlet when the piston is fed into the chamber 17.

A locating ring 19 of resilient heat resistant material encircles a forward portion of the melt body adjacent the extrusion element and is received in co-operating recesses formed in the body portions 10 and 12. The sleeve 26 is formed with a locating ring 27 which is received in co-operating grooves formed in the body portions 10 and 12. The melt body is thus mounted in the body portions 10 and 12 at its outlet and inlet ends by means of the rings 19 and 27 and at a mid-portion by means of the bosses 55.

A resilient mouthpiece in the form of a guide collar 30 is mounted in the body of the gun at the rear and has a guide opening therethrough coaxial with the melt chamber to guide a piston and maintain the piston properly aligned with the melt chamber as it is supplied to the feeding means. The inlet sheath 22, guide collar 30 and ring 19 are conveniently made of silicone rubber, for example.

The parts 10, 12 of the gun body are molded of robust polymer material. The two parts 10, 12 of the body are secured together by fastenings included screws or the like (not shown).

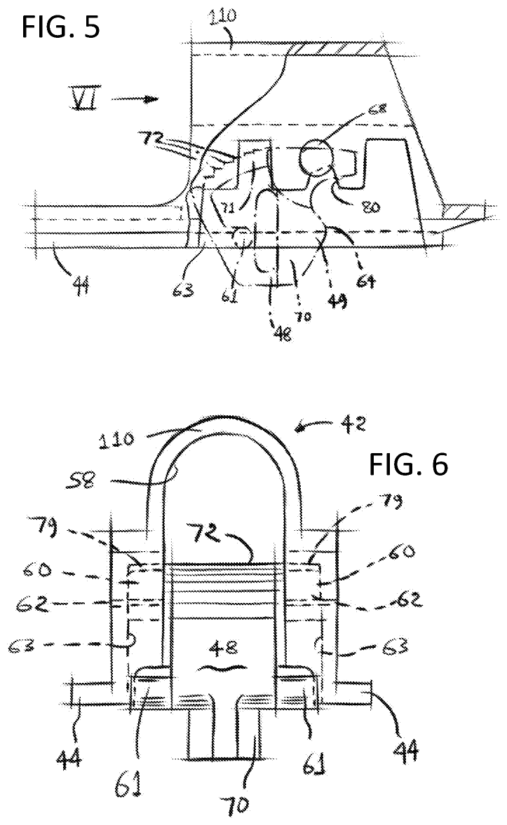

The feeding means 14 (FIGS. 1 and 5 to 9) of the illustrative gun comprises clamping means comprising a carriage 42, mounted for sliding movement towards and away from the melt body 16, by means of flanges 44 which engage in slideways 46, molded in the gun body parts 10, 12 parallel with the axis of the melt chamber 17. It will be apparent that the carriage 42 is thus arranged to move in a direction M defined by the flanges 44 and slideways 46 parallel to the axis of the melt chamber 17. The feeding means 14, further comprises a clamp element 48, pivotally mounted on the carriage 42, and a trigger 50 for actuating the clamp element 48 via a lever 52.

The carriage 42 comprises an upstanding part 110 having a guide aperture 58 through which the piston 54 passes with a small clearance, as it is fed to the melt chamber. The piston 54 is thus supported by the upstanding part 110.

The clamp element 48 has a clamping arm portion 71, extending generally in the direction of the piston feed by which the piston may be engaged in the operation of the feeding means to feed the piston 54 into the melt chamber 17 applying pressure to the cannabis floral material contained therein. In order for the clamping element to adequately grasp the piston 54 without creating indentations on the piston's surface as it is fed even under substantial trigger force and despite variations in diameter of the piston 54, and thus to minimize the risk that the seal between the flexible inlet sheath 22 and the piston 54 be rendered ineffective to prevent blow back of extracted material from the melt chamber 17 under pressure of the advancing piston 54, a piston engaging surface of the clamping arm portion has a somewhat arcuate configuration. The surface is serrated in order to enhance grasping of the piston, the serrations taking the form of several blade portions 72 disposed transversely of the direction of piston feed. These are arranged so that one or more and preferably not less than two may engage the piston 54 during feeding. The piston engaging surface is located so that on operation of the trigger at least two of its blade portions are swung into contact with the piston, even though the piston 54 may be under or oversized compared with the optimal diameter piston.

The clamp element 48 is provided by a casting having pivot pins 60, by which the clamp element is pivotally mounted in the carriage 42, and stabilizing pins 61 located for movement heightwise in guideways 63 in the carriage to an extent limited by slotted surfaces of the guideways. The pivot pins are located at an upper, rearward portion of the clamp element 48. The clamp element is provided with a crank arm 70 having an operating portion in the form of a cam lobe 49 having a convex curved surface 64 located below the pivot pins as viewed in FIGS. 1, 5, 7, 8 and 9, and disposed so that when the feed mechanism is in its rest position as shown in FIG. 1, the curved surface 64 is rearward (considered in the direction of piston feed) of a plane P normal to the direction of piston feed and extending through center lines of the pivot pins.

The lever 52 is mounted on a dowel 53 formed in the part 10 of the gun body for pivotal movement about the dowel. An upper end portion of the lever is formed as a cylindrical cam surface 202 arranged to provide pressure means to co-operate with the cam lobe 49. A lower end portion of the lever is provided with a roller bearing 206 received in a curved slot 208 formed in a rearward portion of the trigger 50 arranged so that pressure exerted to rotate the connecting lever 52 is varied with increased travel of the trigger during a feeding movement. In the rest position shown in FIG. 1, an angle A between a plane Q which includes the line of contact between the curved surface 64 and the cam surface 202 and a plane which includes the direction M in which the carriage is arranged to move, is acute as can be seen from FIG. 1.

The trigger 50 is formed with flanges 210 received in slideways 212 formed in the body parts 10, 12. The trigger and lever are so arranged as to facilitate entry of the roller bearing 206 into the open end of the slot 208 during assembly without risk of disassembly when the apparatus is in use. The trigger 50 is molded of a stiff robust polymer material. The trigger 50 has a pressure plate 98 arranged to be contacted by the finger of an operator to operate the trigger 50. The extent of movement of the trigger is restricted by engagement of the pressure plate 98 with the gun body and by engagement of a stop element also molded integrally with the trigger 50, with the parts 10, 12 of the gun body.

The trigger 50 is arranged to be operated by the operator to pivot the clamp element 48 about the pivot pins 60 to bring blade portions 72 into engagement with the piston 54 supported by the carriage 42, inlet sheath 22, and guide collar 30 to grasp the piston 54 and, with further pressure on the trigger 50 by the operator, to feed the piston 54 into the melt chamber.

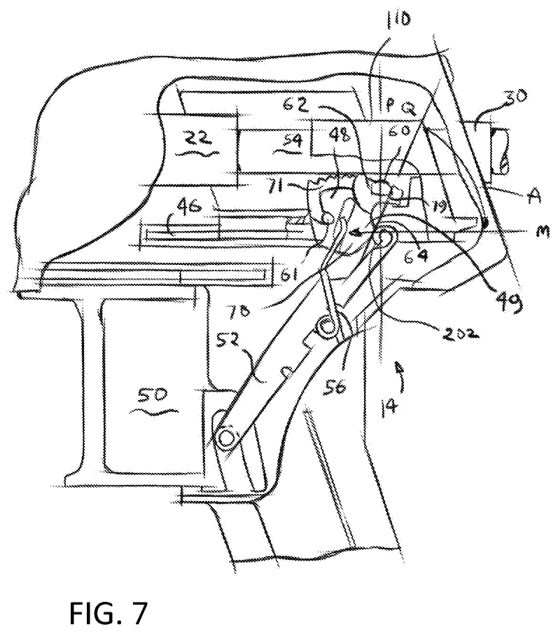

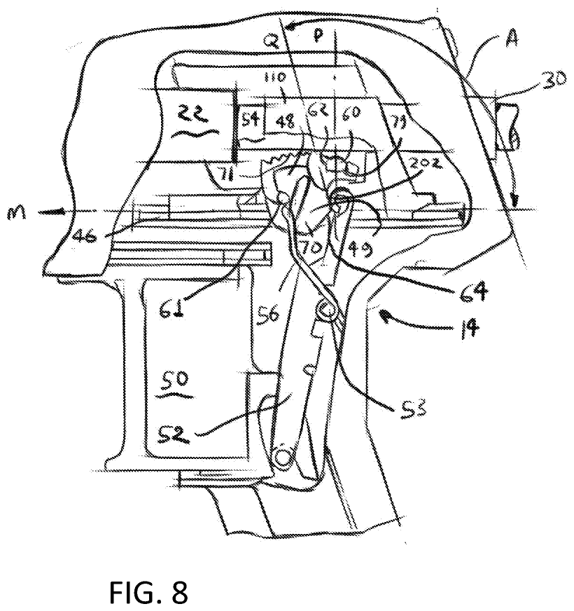

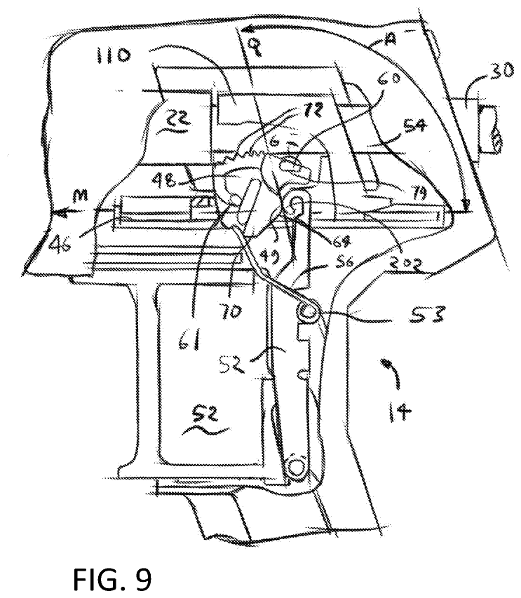

Viewing FIG. 1, when the trigger is moved rearwardly, the lever 52 is caused to rotate in a counter clockwise direction about the dowel 53. The cam surface 202 is thus caused to move in an arc towards the melt body and to press upon the cam lobe 49. Initial pressure causes the clamp element 48 to rotate clockwise about the axis of the pivot pins 60, to an extent limited by engagement of blade portions 72 against the piston. Continued pressure causes the piston to become grasped between the blade portions and the upstanding part 110. During clockwise rotation of the clamp element 48 the disposition of the cam lobe 49 is altered not only in relation to the cam surface 202 but also in relation to the plane P inasmuch as the cam surface 202 engages a portion of the curved surface higher than initially and also the curved surface 64 is moved to a location forward of the plane P (FIG. 7). Also, the angle A becomes less acute, i.e., is increased. Further movement of the cam surface 202 causes the clamp element to act on the carriage 42 to move it towards the melt body, with the piston grasped between the blade portions and the upstanding part. During this movement the cam surface rides up the cam lobe into a region where the angle A has become obtuse (see FIGS. 8 and 9) and pressure is exerted primarily in a direction to move the carriage forward in the direction of the piston feed. By virtue of the disposition of the pivots and the clamping arm and of the shaping of the cam lobe, there is brought about a locking of the clamp element to the piston 54 which is beneficial in reducing the effort needed for grasping the piston 54.

The feeding means 14 comprises a spring 56 extending between an elongated slot in the clamp element 48 and the lever pivot 53, by which the clamp element 48 is biased in a counter clockwise direction as viewed in FIG. 1 and the carriage 42 is biased away from the melt body 16. At the end of a feeding stroke, the trigger may be released, and the spring is effective to swing the clamp element about the pins 60 to lower the clamping arm from the piston and return the clamp element, carriage and lever 52 to their initial positions as shown in FIG. 1 in preparation for another feed stroke.

The feeding means 14 comprising the carriage 42, clamp element 48, lever 52, trigger 50, and spring 56 are constructed such that they can all be assembled to one another and into the parts 10, 12 of the gun body without further equipment or fastening means. The feeding means 14 has been designed to have as few parts as possible and to be assembled reliably and simply in such a way that when the parts 10, 12 of the gun body are secured together the feeding means remains securely assembled. Each of the pivot pins 60 has two arcuate coaxial bearing portions 62 and two parallel flat faces 79 at opposite sides of the pin 60 (FIG. 6). The pivot pins 60 are arranged to be received in coaxial bearing openings 66 at opposite sides of the carriage 42, (FIG. 6) the bearing openings 66 being defined by circular bearing surfaces 68 against which the bearing portions 62 of the pins 60 are supported. Each of the bearing surfaces 68 has an assembly opening 80 extending around a minor arc in the surface remote from the piston 54 supported by the carriage 42, the assembly openings 80 being sufficiently wide for the pivot pins 60 to pass through the assembly openings 80 when the flat faces 79 of the pins 60 are suitably oriented relative to the assembly opening 80 (with the flat faces 79 generally parallel to a radius of the bearing openings 66 bisecting the assembly openings 80), but when assembled in the gun, the arc of pivotal movement of the blade element 48 being restricted so that the pivot pins 60 cannot reach an orientation where the flat faces 79 are sufficiently aligned with the assembly opening 80 to permit the pins 60 to be withdrawn, or escape, through the assembly opening 80.

The feeding means 14 can be assembled simply: the trigger 50 is assembled with the lever 52, and assembled to the body part 10. The clamp element 48 is assembled with the carriage 42 by introduction of the pivot pins 60 into the bearing openings 66, and the carriage is mounted with flanges 44 in the slideways 46 of the body part 10. The spring 56 is assembled with the clamp element and the peg 53. When the feeding means 14 is assembled, the carriage 42 will be urged by the spring 56 to a rear-most position along the slideway 46 and the clamp element 48 will be urged in a counter-clockwise direction, so that the blade portions 72 are lowered with respect to the carriage and the trigger will be urged to an outward position. The stop element will engage the part 10 of the body, preventing further clock-wise movement of the lever (viewing FIG. 1): the orientation of the blade element 48, relative to the carriage 42, is such that the pins 60 are unable to escape from the bearing opening 66 through the assembly opening 80 and likewise the lever 52 is unable to reach an orientation which would allow the bearing, 206 to escape from the slot 208. When the feeding means 14 and the other parts of the gun-type cannabis rosin oil press, including the melt body. 16, inlet sheath 22, guide collar 30, electric leads and resistive heater element, are properly assembled in the part 10 of the gun body the part 12 of the body is aligned with the part 10 and the two parts secured together.

When the trigger is moved rearwardly of the gun by pressure on the pressure plate 98, the lever 52 is caused to pivot about the dowel 53 and to bring about pivotal movement of the clamp element on the carriage and sliding movement of the carriage as described above. Maximum travel of the trigger means is governed by contact of the pressure plate 98 with the body parts 10, 12, in which condition the upstanding part 110 of the carriage 42 is adjacent an inlet end of the inlet sheath 22. When the trigger 50 is released the blade portions are disengaged from the piston and the piston is released from the upstanding part 110 of the carriage 42. The piston 54 is restrained against movement rearwardly by the collar 30 and inlet sheath 22. The carriage 42 slides rearwardly under the pressure of the spring 56 to an extent determined by engagement of the stop element with the body part 10, 12 the carriage sliding relative to the piston 54 so that on a subsequent operation of the trigger 50 a fresh part of the piston 54 is grasped by the blade portions 72 and upstanding part 110 of the carriage 42. As the piston 54 is urged into the melt chamber 17 by the feeding means 14, heat supplied to the melt body 16 by the heating element melts the trichome heads of the cannabis floral material and the extracted material is dispensed through the extrusion element 18 under pressure applied by the feeding means 14 to the piston 54. Relaxation of pressure on the trigger 50 stops feed of piston 54 into the melt chamber 17 and thus extracted material ceases to be dispensed through the extrusion element 18.

The illustrative apparatus comprises electrical circuitry for connecting the heaters to a source of electricity.

When it is desired to use the illustrative apparatus, the circuitry is connected to an electrical power source, e.g., wall outlet, and a piston 54 of circular section may be pushed into the apparatus through the guide collar 30, between the upstanding part 110 and the clamp element 48, into the inlet sheath 22, where it is grasped by the distended lip 32 of the inlet sheath 22, and into the inlet of the melt chamber. Operation of the trigger when cannabis floral material in the melt chamber 17 is heated brings about feeding of the piston as aforesaid. As the piston 54 is fed into the melt chamber 17, the cannabis rosin oil is softened and melted, leaving a substantially cone-like solid residue which during continued feeding is forced onto the inner edge surfaces of the fin elements. Thus, the melt chamber walls and the fin elements transfer heat to the cannabis floral material. As the piston 54 is progressively fed into the melt chamber 17, it serves to force heat softened or extracted material before it between the fin elements and through the slots of the outlet and ultimately from the extrusion element.

The above described embodiments are set forth by way of example and are not for the purpose of limiting the scope of the present general inventive concept. It will be readily apparent that obvious modifications, derivations and variations can be made to the embodiments without departing from the scope of the invention. Accordingly, the claims appended hereto should be read in their full scope including any such modifications, derivations and variations.

What is claimed is:

1. A handheld gun-type cannabis press and dispenser, which includes:
an inlet for receiving cannabis material,
a melt chamber in communication with said inlet and having a narrowing volumetric surface therein such that received cannabis material therethrough is pressed, said melt chamber equipped to apply heat to the cannabis material as it passes therethrough; and
an outlet in communication with said melt chamber through which heated pressed cannabis material and rosin extract passes.

2. The handheld gun-type cannabis press and dispenser of claim 1, wherein said melt chamber includes an electrically-powered resistive heating element.

3. The handheld gun-type cannabis press and dispenser of claim 1, wherein said melt chamber includes a heat conductive alloy.

4. The handheld gun-type cannabis press and dispenser of claim 1, wherein said melt chamber includes a plurality of longitudinally extending spaced surfaces.

5. The handheld gun-type cannabis press and dispenser of claim 4, wherein said longitudinally extending spaced surfaces extend from said inlet to said outlet.

6. The handheld gun-type cannabis press and dispenser of claim 5, wherein said longitudinally extending spaced surfaces provide slotted fenestrations which taper from wider at said inlet to narrow at said outlet.

7. The handheld gun-type cannabis press and dispenser of claim 1 wherein said outlet includes a single orifice.

8. The handheld gun-type cannabis press and dispenser of claim 1 wherein said outlet includes an extrusion array element.

9. The handheld gun-type cannabis press and dispenser of claim 8, wherein said extrusion array element incorporates a filter.
